(19) United States
(12) Patent Application Publication
(10) Pub. No.: US 2002/0171360 A1
(43) Pub. Date: Nov. 21, 2002

(54) Compact high-voltage electric light-bulb

(76) Inventors: Helmut Davideit, Petersdorf (DE); Sigbert Mueller, Neusaess (DE)

Correspondence Address: OSRAM SYLVANIA INC, 100 ENDICOTT STREET, DANVERS, MA, 01923, US

(21) Appl. No.: 10/110,168

(22) PCT Filed: Jul. 24, 2001
(86) PCT No.: PCT/DE01/02800

(30) Foreign Application Priority Data
Aug. 14, 2000 (DE) 10040253.4

(51) Int. Cl. H01K 1/50

(52) U.S. Cl. 313/578; 313/579

(57) ABSTRACT

The compact high-voltage incandescent lamp according to the invention has as a luminous element a threefold winding in the form of a double helix (4) which is formed, for its part, from a coiled-coil filament (4a-4c). It is possible in this way to implement high-voltage incandescent lamps with compact dimensions and high luminances.

### TECHNICAL FIELD

The invention relates to a compact electric high-voltage incandescent lamp.

The term high-voltage incandescent lamp is to be understood in a generalized way to include incandescent lamps which can be operated without the interposition of a voltage transformer, for example a transformer or electronic converter, directly on system voltage, for example 115 V or 230 V.

In particular, this is a compact high-voltage halogen incandescent lamp, for example for operating on 230 V system voltage. In halogen incandescent lamps, the lamp bulb, which is usually filled with inert gas, for example with N₂, Xe, Ar and/or Kr, is additionally given halogen additives which maintain a tungsten-halogen cyclic process in order to counteract bulb blackening.

This type of lamp is used both in normal lighting and for particular lighting tasks, in combination with an optical reflector, for example in projection technology.

As is already the case with low-voltage halogen incandescent lamps, the trend in high-voltage halogen incandescent lamps is also increasingly in the direction of compact lamp dimensions. The compactness of the lamp and, in particular of the luminous element of the lamp is of great importance precisely in the case of projection applications.

However, this is opposed by the large length of the wire which is typically required in the case of a luminous element (incandescent filament) for high-voltage halogen incandescent lamps. The reason for this is associated, inter alia, with the relationship between the electric resistance R of the incandescent filament and the desired electric power consumption P for a given supply voltage U. Specifically, the relationship P=U²/R holds. Since the supply voltage U features quadratically in the present relationship, the resistance of the incandescent filament must be correspondingly substantially increased upon transition from the low-voltage to the high-voltage region, in order to realize the same power consumption of the lamp. For its part, the resistance R of the wire filament is a function, inter alia, of the wire diameter and the wire length. Thus, for high-voltage halogen incandescent lamps the wire is typically between 1 m and 2 m long, depending on the wire diameter and power (here, for example, 50 μm and 150 W or 190 μm and 1000 W).

Consequently, the incandescent filaments are generally longer for high-voltage lamps than for low-voltage types given comparable power consumption, wire diameter and filament pitch.

### PRIOR ART

A compact halogen incandescent lamp with a coiled-coil filament is already known from the document EP-A 0 743 673. The coiled-coil filament is arranged inside a cylindrical lamp bulb, specifically transverse to the longitudinal axis of the lamp. Particular data on the operating voltage cannot be derived from this document. However, it does at least seem to be unsuitable for operating on 230 V.

GB-A 2 302 208 exhibits a compact halogen incandescent lamp using low-voltage to medium-voltage technology (for example 6 to 36 V) having a coiled-coil filament and a layer which is applied to the wall surface of the lamp bulb and reflects IR radiation. The coiled-coil filament is arranged on the axis of the cylindrical part of the lamp bulb.

U.S. Pat. No. 4,499,401 discloses an incandescent lamp having a threefold filament which is arranged transverse to the longitudinal axis of the lamp inside a pear-shaped lamp bulb. This incandescent lamp has an Edison screw base and is also suitable, inter alia, for operation on 230 V. However, because of the transverse filament arrangement it is of relatively high volume and therefore not suitable, in particular, for projection applications.

Finally, HV incandescent lamps having a plurality of filament segments are also known, the individual filament segments being fixed inside the lamp bulb by a complicated filament frame. However, the poor quality of illumination in the use of such a lamp in an optical reflector is disadvantageous. Specifically, the spatially extended and segmented incandescent filament results in an undesired nonuniform luminosity distribution.

### SUMMARY OF THE INVENTION

It is the object of the present invention to provide a compact high-voltage incandescent lamp. Further aspects are to provide a higher luminance and efficiency, and a better quality of illumination in the event of use in an optical reflector.

This object is achieved by a lamp having the features of claim 1. Particularly advantageous refinements are to be found in the dependent claims.

Also claimed is protection for an illuminating system having the lamp according to the invention and an optical reflector.

The compact high-voltage incandescent lamp according to the invention has as a luminous element a threefold winding in the form of a double helix which, for its part, is formed from a conventional double winding.

In order to illustrate the form of the luminous element, the double helix can be regarded as a coiled-coil filament made from two spatially interlocking coiled-coil filament sections, the two coiled-coil filament sections being implemented as similar helical curves which are, however, contrarotating as regards the current flow. These two helical curves are arranged displaced relative to one another by approximately half a pitch in the axial direction such that their two longitudinal axes coincide. Here, the pitch is defined as the distance within which the helical curves execute a complete revolution. The two coiled-coil filament sections merge into one another at a first end of the luminous element. At the opposite end of the luminous element, the coiled-coil filament sections are connected in each case to a supply lead. The full system voltage is present at the supply leads during operation of the lamp. In a 230 V AC voltage system, for example, this means a peak voltage of approximately 311 V. An increased risk of voltage flashovers and/or arcing therefore exists in the initial region, bordering directly on the supply leads, of the two spatially interlocking coiled-coil filament sections. In order at least to reduce this risk, it can be advantageous to increase the pitch in this initial region, that is to say to provide a pitch increasing in the direction of the supply leads. Specifically, the initial regions of the two double helix halves are then, as desired, less closely neighboring, but there is no excessive increase in the overall length of the luminous element. As an alternative, or complement, it can also be advantageous to provide a diameter of the double helix which increases in the direction of the supply leads.

In any case, in this way the long incandescent wire required for high-voltage incandescent lamps is designed as a very compact, unipartite, that is to say unsegmented, luminous element in the form of the threefold winding explained above. In addition to the compactness of the double-helix-shaped luminous element, it is also advantageous that the structure thereof is relatively closed. Consequently, it is also possible in the case of high-voltage incandescent lamps to achieve, firstly, high luminances and, secondly,—in the case of installation in an optical reflector—a good quality of illumination.

In a particularly compact development, the main part of the lamp bulb has the shape of a cylinder with a circular cross section. The elongated double helix is oriented in this case axially inside the cylindrical lamp bulb. In this way, lamp bulbs and luminous elements are well coordinated with one another geometrically, the result of this being the particularly compact design of the lamp.

Moreover, it can be advantageous for the purpose of further increasing efficiency additionally to provide the wall surface of the lamp bulb in a way known per se with a layer which reflects infrared (IR) radiation (see, for example, the already-cited GB-A 2 302 208). This layer retroreflects a majority of the IR radiant power emitted by the luminous element. The increase in the lamp efficiency thereby achieved can be utilized, on the one hand, to increase the temperature of the luminous element given a constant electric power consumption and, consequently, to raise the luminous flux. On the other hand, it is possible to achieve a prescribed luminous flux together with a low electric power consumption—an advantageous “energy-saving effect”. A further advantageous effect is that because of the IR layer substantially less IR radiant power is emitted through the lamp bulb, and thus the surroundings are heated much less than in the case of conventional incandescent lamps.

In a particularly efficient embodiment of a lamp with a layer reflecting IR radiation, the main part of the lamp bulb is designed as an ellipsoid or at least approximately as an ellipsoid. This type of bulb permits a particularly efficient feedback of the IR radiation. More details on this are to be found in EP-A 0 765 528, for example.

### DESCRIPTION OF THE DRAWINGS

The aim below is to explain the invention in more detail with the aid of exemplary embodiments. In the drawing:

FIG. 1a shows a high-voltage halogen incandescent lamp with a double-helix luminous element and cylindrical lamp bulb, in side view,

FIG. 1b is as FIG. 1a, but rotated by 90°,

FIG. 2a shows a high-voltage halogen incandescent lamp with a double-helix luminous element and ellipsoidal lamp bulb, in side view,

FIG. 2b is as FIG. 2a, but rotated by 90°,

FIG. 3 shows an illustration on the principle of the production of the double-helix luminous element from a double winding.

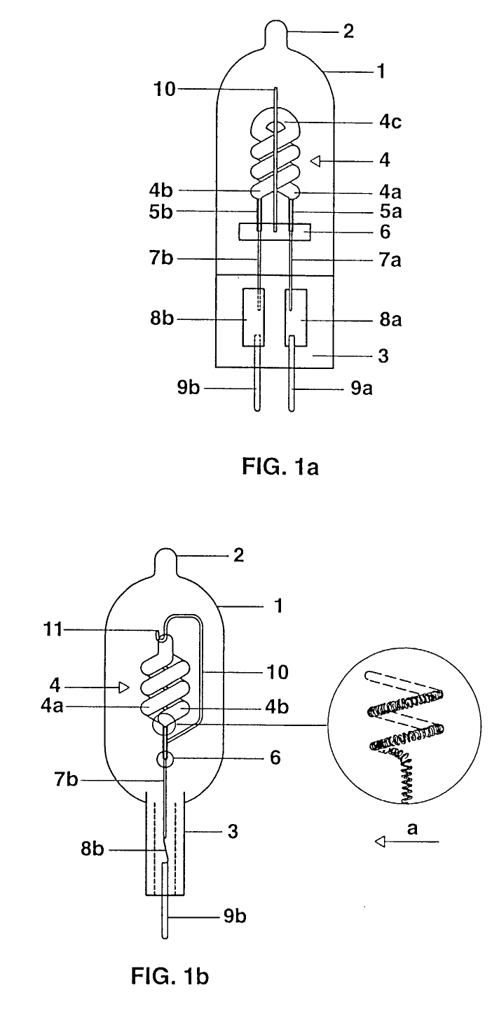

FIGS. 1a, 1b show a schematic illustration of a side view and a view, rotated by 90° thereto, of a high-voltage halogen incandescent lamp according to the invention pinched at one end for operating on 230 V system voltage. The electric power consumption and the luminous efficiency are 1000 W and 25 lm/W, respectively.

The lamp has a cylindrical lamp bulb 1 made from quartz glass, which is shaped at one end to form a dome with a closed tip 2. The lamp bulb 1 is sealed at the other end with the aid of a pinch seal 3. The lamp bulb 1 surrounds a halogen filling known per se, as is usual for halogen incandescent lamps. The filling constituents are, for example, xenon (Xe) and nitrogen (N₂) and a few percent of a halogen, for example dibromomethane (DBM). The filling pressure is approximately 3 bar.

A unipartite luminous element 4 is arranged axially inside the lamp bulb 1. As may be seen from the close-up in FIG. 1b, it comprises a coiled-coil filament 4a-4c, known per se made from tungsten wire which is, for its part, shaped to form a double helix. The double helix 4 has two spatially interlocking coiled-coil filament sections 4a, 4b in the shape of helical curves, which merge continuously into one another by means of an arcuate coiled-coil filament section 4c. The sections 4a, 4b, in the shape of helical curves, of the double helix 4 each have one and a half turns. The outside diameter and the length of the double helix 4 are approximately 11 mm and 16 mm, respectively. Consequently, the double-helix luminous element 4 for operation on 230 V system voltage and a power consumption of 1000 W is very compact.

The two singly spiraled ends 5a, 5b of the luminous element are fixed in a quartz beam 6 which is, for its part, supported by two wire pins 7a, 7b, which also serve as supply leads. The latter end in the pinch seal 3, where they are respectively connected to a molybdenum foil 8a, 8b. The molybdenum foils 8a, 8b are, finally, connected in each case to a supply feed pin 9a, 9b leading to the outside.

The end of the double-helix luminous element 4 near the tip 2, that is to say the coiled-coil filament section 4c, is fixed with the aid of a holder 10 made from wire. For this purpose, the wire holder 10 is shaped to form an elongated bow which ends in an eye 11. The section 4c connecting the two halves of the double helix 4 is suspended in this eye 11. The other end of the holder 10 is fastened in the quartz beam 6.

Alternatively, the other end of the holder 10 can also be lengthened up to the pinch seal 3. It is possible in this case to dispense with the aforementioned quartz beam 6, since the holder is then fixed directly in the pinch seal. In some circumstances, it is also possible to dispense entirely with a holder, specifically when the stability of the filament is sufficiently high, for example given an appropriately large wire diameter.

The halogen incandescent lamp of FIGS. 1a, 1b combines a high-voltage suitability with particular compactness with the aid of the triply wound compact double-helix luminous element 4 and the cylindrical lamp bulb 1, adapted thereto and pinched at one end, with an overall length of approximately 60 mm and a diameter of approximately 20 mm.

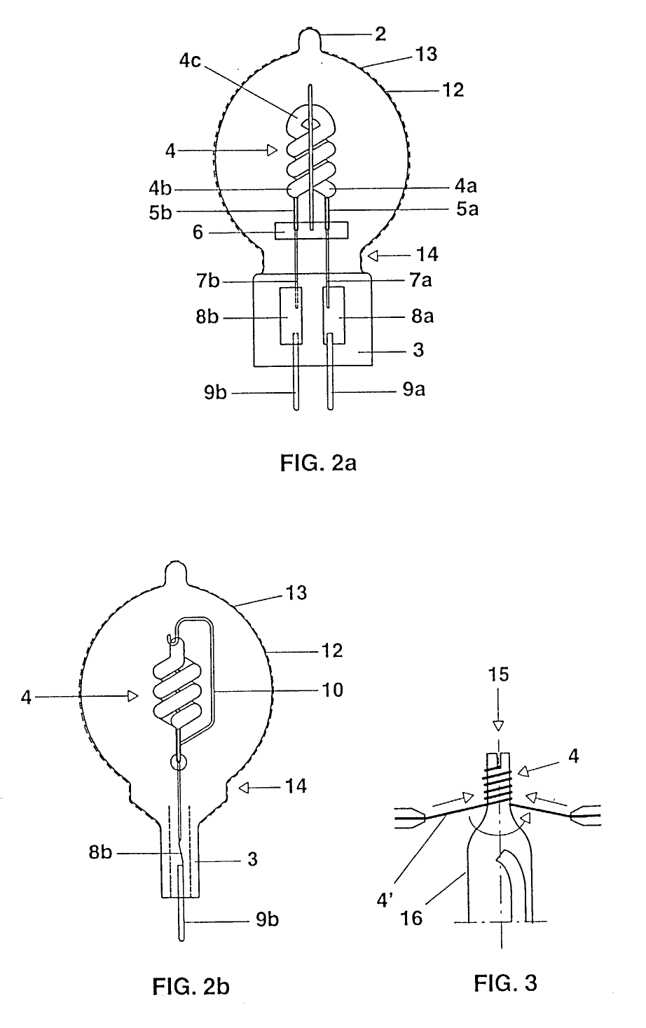

FIGS. 2a, 2b are schematics of a further exemplary embodiment of a high-voltage halogen incandescent lamp (230 V) according to the invention and pinched at one end, in a side view and in a view rotated by 90° thereto. Identical features to those in FIGS. 1a, 1b are provided with identical reference symbols.

By contrast with the exemplary embodiment of FIGS. 1a, 1b the lamp in FIGS. 2a, 2b has an ellipsoidal lamp bulb 12 whose outer wall surface is provided with a layer system 13 which reflects IR radiation. The layer system 13 comprises an interference filter known per se—usually a sequence of alternating dielectric layers of different refractive indices. In the present case, this is an alternating sequence of Nb₂O₅ or SiO₂ layers.

The lamp bulb 12 has a pronounced constriction 14 in the region of the lamp neck, that is to say immediately in the region of the transition of the lamp bulb 12 to the pinch seal 3, which is relatively wide because of the foil lead-through. A particularly large active reflection surface 13 is thereby achieved with reference to the overall lamp bulb, and consequently a correspondingly high lamp efficiency is achieved.

In this way, the halogen incandescent lamp of FIGS. 2a, 2b combines the high-voltage suitability with the IR-layer technology and compactness.

In a lighting system (not illustrated), the lamp of FIG. 1 and, alternatively, that of FIG. 2 is installed in an optical reflector.

The production of the double-helix luminous element 4 according to the invention from a double winding 4′ is illustrated in principle in FIG. 3. For this purpose, the double winding 4′ (details not illustrated) is inserted centrally into the groove 15 of a winding mandrel rail 16. Rotating the winding mandrel rail 16 forms from the double winding 4′ a double helix 4 which is subsequently removed from the winding mandrel rail 16 and installed in the lamp according to the invention in accordance with FIGS. 1a, b and 2a, b. The configuration of the winding mandrel rail 16 in the shape of a bottleneck permits a double helix to be produced with a diameter increasing in the direction of the supply leads.

1. A compact high-voltage incandescent lamp, in particular a high-voltage halogen incandescent lamp, having a lamp bulb (1; 12) and a luminous element (4) which is made from a triply wound incandescent wire, which is arranged inside the lamp bulb (1; 12) and is connected in an electrically conducting fashion to two supply leads (9a, 9b) leading outward, the lamp bulb (1; 12) and the supply leads (9a, 9b) defining a longitudinal axis of the lamp, and the luminous element being a double helix (4) which is formed from a coiled-coil filament (4a-4c).

2. The incandescent lamp as claimed in claim 1, in which the double helix (4) is oriented axially in the lamp bulb (1; 12).

3. The incandescent lamp as claimed in claim 1 or 2, in which the lead of the double helix increases in the direction of the supply leads.

4. The incandescent lamp as claimed in one of the preceding claims, in which the diameter of the double helix increases in the direction of the supply leads.

5. The incandescent lamp as claimed in one of the preceding claims, in which the lamp bulb (1; 12) is rotationally symmetrical.

6. The incandescent lamp as claimed in claim 5, in which the lamp bulb is designed in the shape of a cylinder (1).

7. The incandescent lamp as claimed in claim 5, in which the lamp bulb is designed in the shape of an ellipsoid (12).

8. The incandescent lamp as claimed in claim 7, in which the lamp bulb (12) has a constriction (14) in the region of the lamp neck.

9. The incandescent lamp as claimed in one of the preceding claims, in which the two supply leads (9a, 9b) are guided to the outside in a gastight fashion with reference to the longitudinal axis of the lamp on one side of the lamp bulb (1; 12).

10. The incandescent lamp as claimed in claim 9, in which arranged inside the lamp bulb (1; 12) is a holder (10) on which the end (4c) of the double helix averted from the supply leads (9a, 9b) is fixed.

11. The incandescent lamp as claimed in one of the preceding claims, in which the wall surface of the lamp bulb (12) is provided with a layer (13) reflecting IR radiation.

12. An illuminating system having an optical reflector and a lamp as claimed in one of claims 1 to 11.
